(19) United States
(12) Patent Application Publication
(10) Pub. No.: US 2016/0094019 A1
(43) Pub. Date: Mar. 31, 2016

(54) SCREWDRIVER HAVING CABLE-STRIPPING STRUCTURE

(71) Applicant: GONG FONG ENTERPRISE CO., LTD., TAINAN CITY (TW)

(72) Inventor: YU-LUN CHEN, TAINAN CITY (TW)

(21) Appl. No.: 14/501,283

(22) Filed: Sep. 30, 2014

(51) Int. Cl. H02G 1/12; B25G 1/00; B25F 1/00; B25B 15/02

(52) U.S. Cl. CPC H02G 1/1214; B25B 15/02; B25G 1/005; B25F 1/00

(57) ABSTRACT

A screwdriver having a cable-stripping structure is disclosed. The screwdriver includes a grip and a screw-driving shaft. In the cable-stripping structure, the grip has a combining portion provided with a cable-stripping groove and a slit crossing the cable-stripping groove. The cable-stripping structure further has a pressing plate combined with the combining portion and has an abutting groove corresponding to the cable-stripping groove. A knife is installed in the slit and has a cable-stripping blade that is sized and shaped in accordance with the cable-stripping groove. The knife further has a retaining block passing through a through hole of the grip and a retaining hole of the pressing plate successively, so as to allow the pressing plate to be pressed and move along the screw-driving shaft. Thereby the cable-stripping structure facilitates stripping electric wires of different diameters and bending cores of the stripped electric wires.

### BACKGROUND OF THE INVENTION

1. Technical Field

The present invention relates to a screwdriver capable of stripping electric wires of various diameters and bending cores of stripped electric wires.

2. Description of Related Art

The conventional screwdriver is a simple tool exclusively used for screwing screws. Where wiring for electrical apparatuses is required, a worker going for the work has to additionally take one or more cable strippers with him/her, which is inconvenient. As an improvement, Taiwan Patent No. M456267 titled “Hand Tool Having Cable-Stripping Function” that has been issued on Jul. 1, 2013 discloses a hand tool. This prior-art hand tool comprises a tool member, a grip and a cutting member. The grip has one end fixedly combined with the tool member and an opposite end provided with an axial hole. A cable-receiving chamber is formed inside the grip and communicated with the axial hole. The cutting member is such installed in the grip that its blade faces the cable-receiving chamber. The hand tool thus is enabled to strip cables. Since the cutting member is contained within the grip, the cable-stripping function can be performed safely.

However, the prior-art hand tool is made to strip cables of only a single size and provides no means to bend the stripped part of a cable. Besides, the structure it employs is relatively complex and involves numerous components, so the manufacturing and assembly are troublesome and time-consuming. For these reasons, the prior-art device needs to be further improved.

### SUMMARY OF THE INVENTION

In view of this, the present invention provides a screwdriver having a cable-stripping structure that facilitates stripping cables and bending cores of stripped cables. The screwdriver has a grip and a screw-driving shaft, and the cable-stripping structure is characterized in: the grip including a combining portion having a receiving recess for allowing the screw-driving shaft to be inserted therein, wherein the combining portion further has at least one cable-stripping groove, a slit extending from a periphery of the combining portion toward and crossing the cable-stripping groove, and a through hole communicating the slit and the receiving recess; a spring member being mounted around the screw-driving shaft and having a first end and a second end, wherein the first end is received in the receiving recess of the grip; a pressing plate being combined with the combining portion of the grip, wherein the pressing plate has a retaining hole corresponding to the through hole, an abutting groove corresponding to the cable-stripping groove, and a fixing hole; and a knife being installed in the slit of the grip, and having at least one cable-stripping blade that is sized and shaped in accordance with and aligned with the cable-stripping groove, wherein the knife further has a retaining block passing through the through hole and the retaining hole successively, so that the pressing plate is allowed to be moved along the screw-driving shaft by a pressing force in a positionally controlled manner.

The combining portion of the grip has two said cable-stripping grooves that are two round-bottom grooves having different diameters, and two said knives are provided to mate the two cable-stripping grooves, in which each of the two knives has a said cable-stripping blade that is sized and shaped in accordance with the corresponding cable-stripping groove.

The two cable-stripping grooves are parallel to each other.

The slit is normal to the cable-stripping groove when crossing the cable-stripping groove.

The spring member is a compression spring.

The pressing plate has a raised portion, and the raised portion has an axial hole for allowing the screw-driving shaft to pass therethrough.

The axial hole of the raised portion receives the second end of the spring member.

The retaining hole is correspondingly formed on the raised portion as a lengthwise groove.

The abutting groove is a round-bottom groove sized and shaped identically to the cable-stripping groove.

The fixing hole is lined by a sleeve.

The present invention has the following advantages:

1. The present invention has the cable-stripping structure capable of serving to strip cables of different diameters as required by an in-site wiring operation.

2. The present invention is also useful to help bending a core of a cable that has been stripped so as to facilitate subsequent wire wilding.

3. The present invention implements a streamlined configuration, so its manufacturing and assembly require less time and reduced costs as compared to the prior-art device. Also, its use is easy and convenient.

### BRIEF DESCRIPTION OF THE DRAWINGS

FIG. 1 is an exploded view according to an embodiment of the present invention.

FIG. 2 is a perspective view according to an embodiment of the present invention.

FIG. 3 is a plane view according to an embodiment of the present invention taken from the end of the screw-driving shaft.

FIG. 4 is a cross-sectional view according to an embodiment of the present invention taken along Line IV-IV of FIG. 3.

FIG. 5 is an enlarged view of Part B of FIG. 4.

FIG. 6 is a perspective view of the pressing plate according to an embodiment of the present invention.

FIG. 7 is an applied view according to an embodiment of the present invention showing an electric wire to be stripped is placed in the first cable-stripping groove.

FIG. 8 is a schematic drawing illustrating the pressing plate according to an embodiment of the present invention pressed.

FIG. 9 is schematic drawing illustrating the electric wire having been partially stripped.

FIG. 10 is a cross-sectional view according to an embodiment of the present invention taken along Line X-X of FIG. 3.

FIG. 11 is a schematic drawing illustrating in Part C of FIG. 10 a fixing hole and a sleeve arranged therein facilitating bending the core of the stripped electric wire.

### DETAILED DESCRIPTION OF THE INVENTION

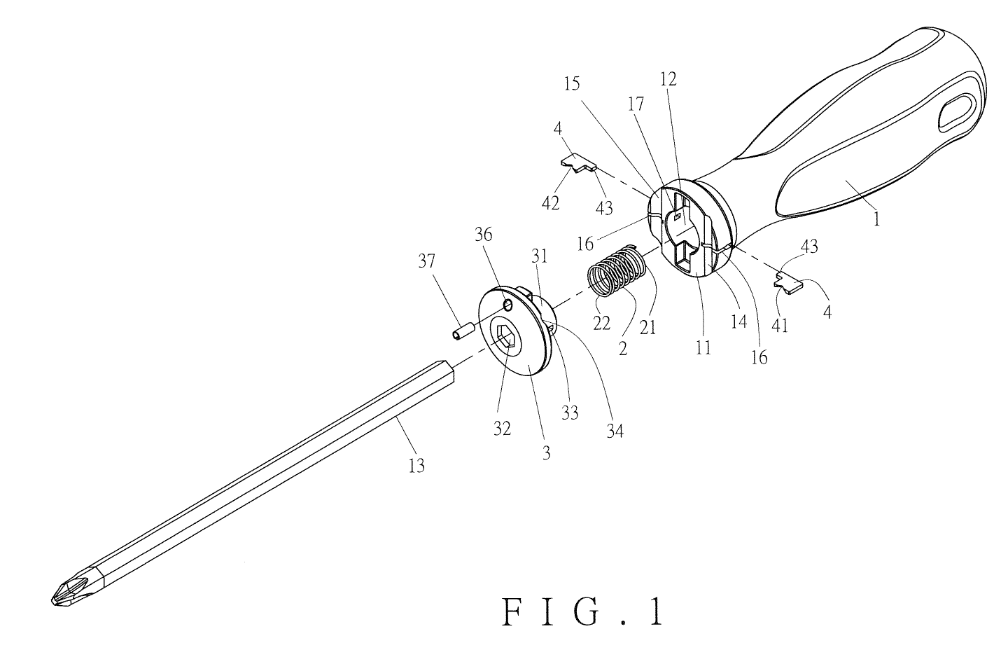

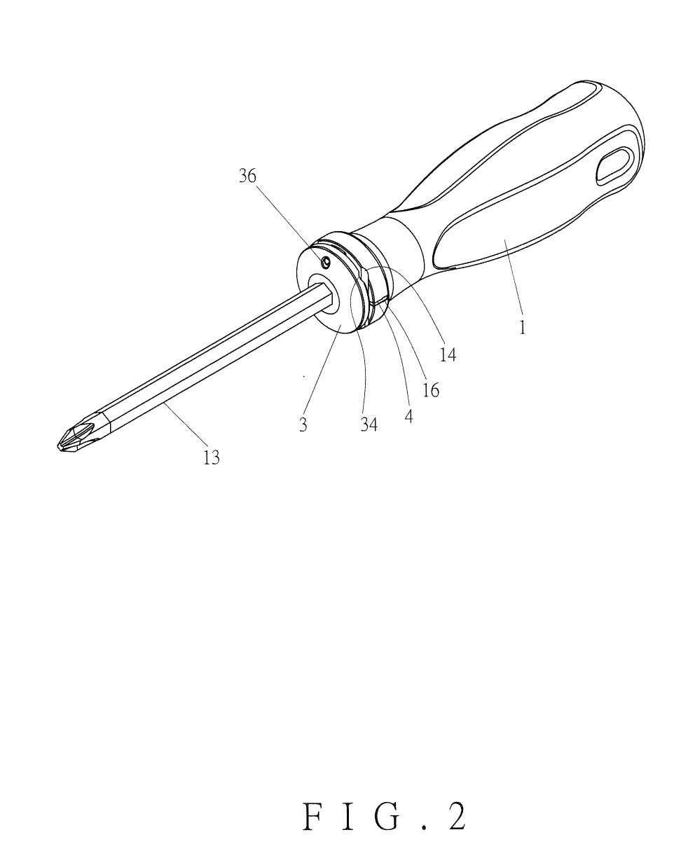

Referring to FIG. 1 and FIG. 2, in one embodiment of the present invention, a screwdriver comprises a grip (1), a spring member (2), a pressing plate (3) and knives (4).

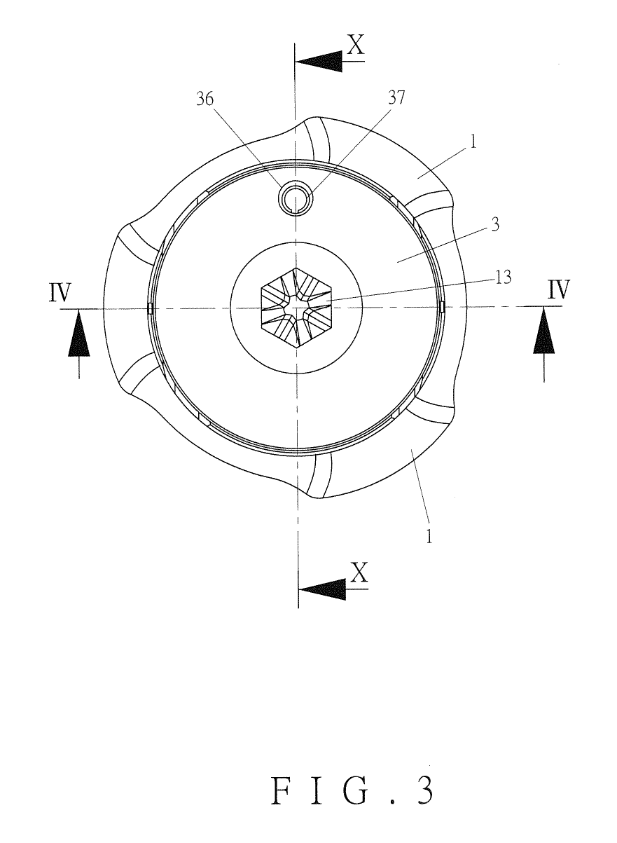

The grip (1) has a combining portion (11). The combining portion (11) is provided with a receiving recess (12) for fixedly receiving a screw-driving shaft (13) (as shown in FIG. 3). The combining portion (11) further has a first cable-stripping groove (14) and a second cable-stripping groove (15) that are parallel to each other. It is to be noted that while the depicted embodiment has two cable-stripping grooves, the present invention can be well realized by using one or more than two cable-stripping grooves, without limitation. The first cable-stripping groove (14) and the second cable-stripping groove (15) are round-bottom grooves having different diameters. Two slits (16) extend from the periphery of the combining portion (11) normally toward and cross the first cable-stripping groove (14) and the second cable-stripping groove (15), respectively. The two slits (16) not extending to the receiving recess (12) are each communicated with the receiving recess (12) via a through hole (17).

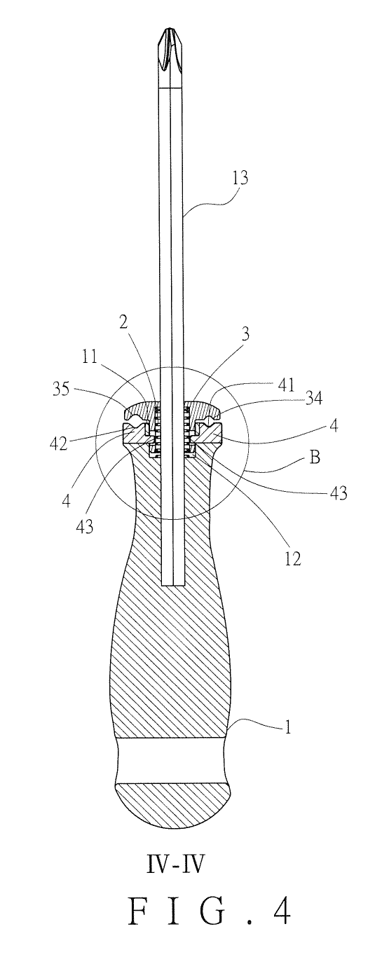

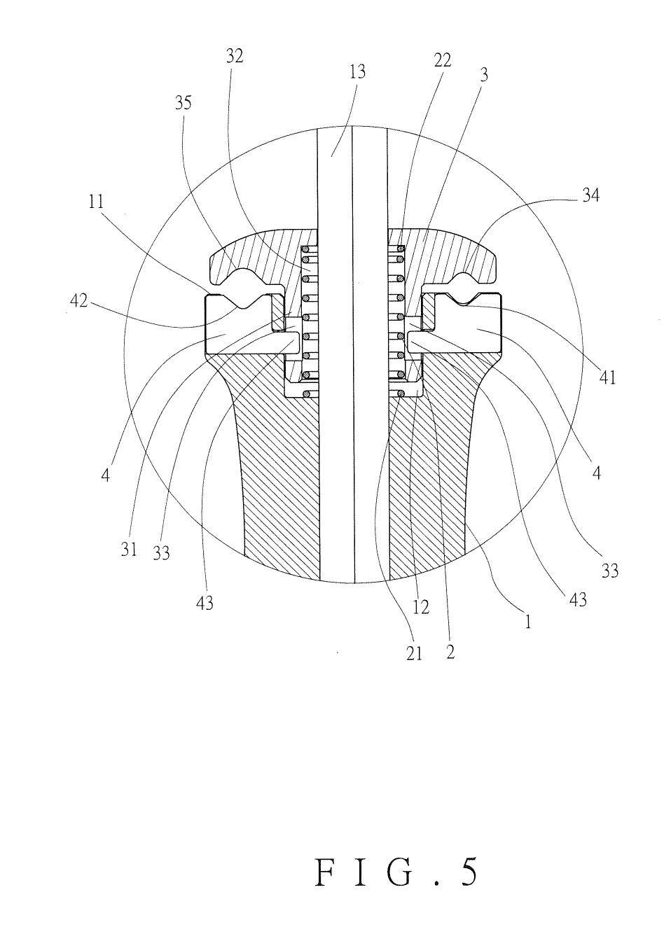

The spring member (2) is mounted around the screw-driving shaft (13). The spring member (2) may be a compression spring having a first end (21) and a second end (22). The first end (21) is received in the receiving recess (12) of the grip (1), as shown in FIG. 4 and FIG. 5.

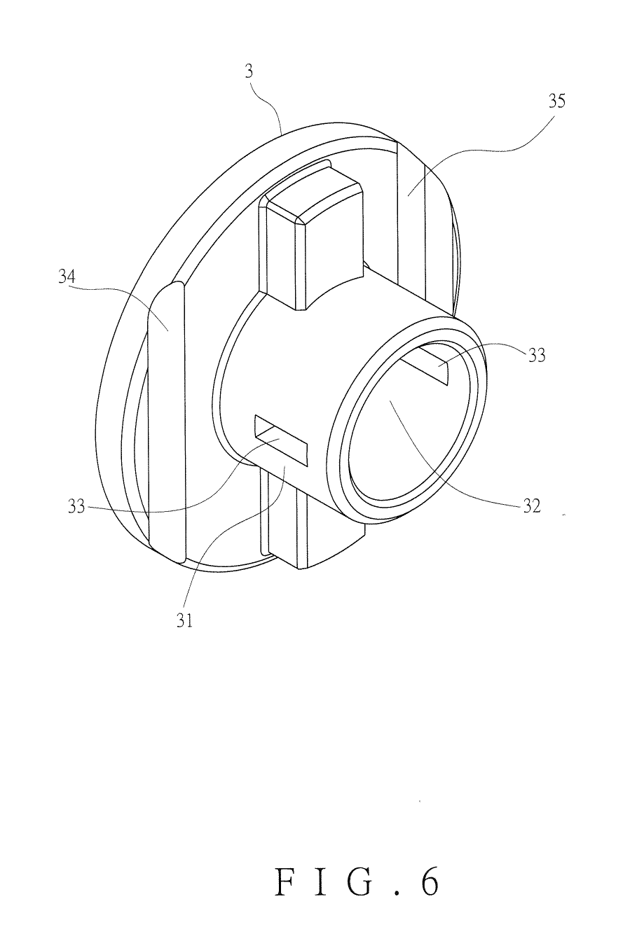

The pressing plate (3) is combined with the combining portion (11) of the grip (1) in a movable manner. The pressing plate (3) has a raised portion (31), as shown in FIG. 6. The raised portion (31) is formed with an axial hole (32) that allows the screw-driving shaft (13) to pass therethrough, so that the pressing plate (3) can be pressed to move along the screw-driving shaft (13) in a positionally controlled manner. The axial hole (32) of the raised portion (31) also receives the second end (22) of the spring member (2), so that the spring member (2) is held between the combining portion (11) of the grip (1) and the raised portion (31) of the pressing plate (3). The raised portion (31) has two retaining holes (33) each aligned with a corresponding one of the two through holes (17) of the grip (1). The retaining hole (33) is a lengthwise groove. Further, the pressing plate (3) has a first abutting groove (34) and a second abutting groove (35) as two round-bottom grooves that are corresponding to and sized identically to the first cable-stripping groove (14) and the second cable-stripping groove (15), respectively. Moreover, the pressing plate (3) has a fixing hole (36) that is lined by a metal sleeve (37).

The two knives (4) herein is each installed in a corresponding one of the two slits (16) of the grip (1). One of the knives (4) has a first cable-stripping blade (41), while the other has a second cable-stripping blade (42). The first cable-stripping blade (41) corresponds to the first cable-stripping groove (14) and has a cutting edge sized and shaped according to the round bottom of the first cable-stripping groove (14). The second cable-stripping blade (42) corresponds to the second cable-stripping groove (15) and has a cutting edge sized and shaped according to the round bottom of the second cable-stripping groove (15). The two knives (4) each has a retaining block (43) that passes through the through hole (17) of the grip (1) and the retaining hole (33) of the pressing plate (3) successively. The combination between the retaining hole (33) and the retaining block (43) allows the pressing plate (3) to move along the screw-driving shaft (13) while preventing the pressing plate (3) from leaving the combining portion (11) of the grip (1).

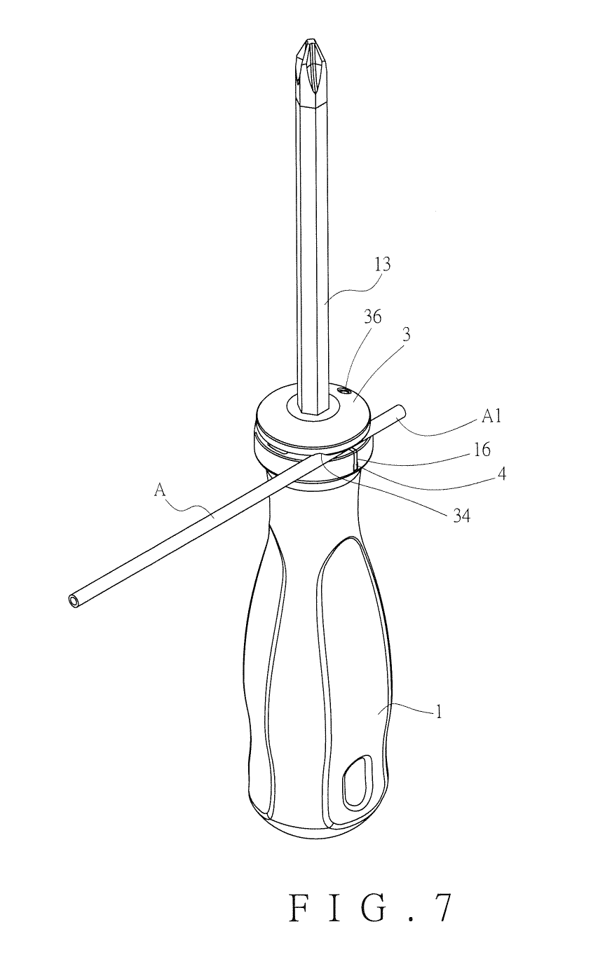

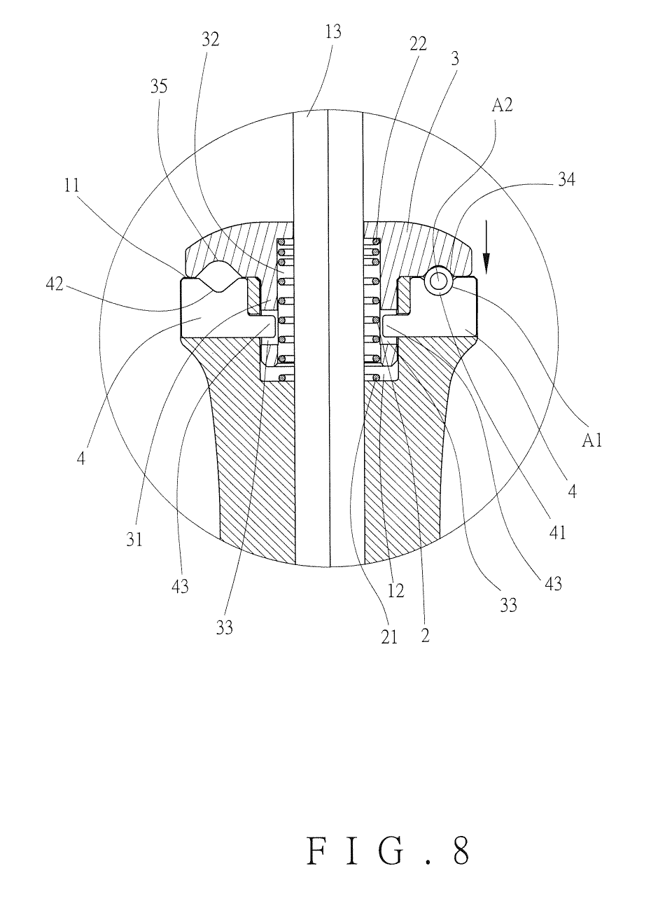

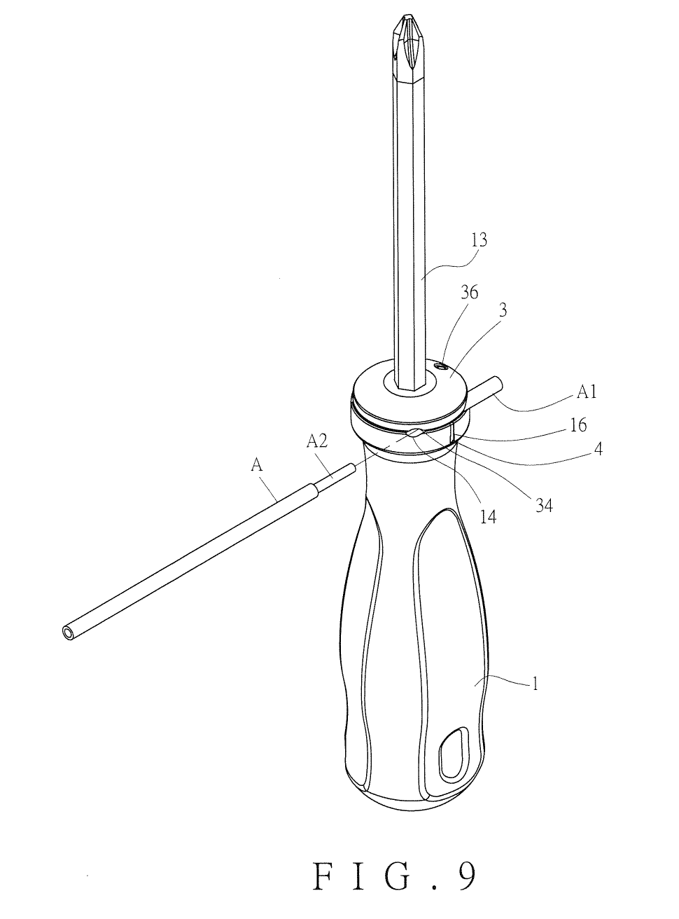

In use, in addition to be using as a normal screwdriver that drives screws, the present invention can also strip an electric wire (A). Referring to FIG. 7, an electric wire (A) has its to-be-striped end (A1) placed in one of the first cable-stripping groove (14) and the second cable-stripping groove (15) that fits its diameter. In the present embodiment, the first cable-stripping groove (14) is used for example. When the to-be-striped end (A1) of the electric wire (A) is placed on the first cable-stripping blade (41) in the first cable-stripping groove (14) according to the desired cable-stripping length, the pressing plate (3) can be pressed into the combining portion (11), so as to make the spring member (2) compressed between bottoms of the receiving recess (12) of the grip (1) and the axial hole (32) of the pressing plate (3), as shown in FIG. 8. As the pressing plate (3) is pressed and moves, the first abutting groove (34) is also drawn toward the first cable-stripping groove (14) so that the to-be-striped end (A1) of the electric wire (A) is grasped therebetween. At this time, by pulling the electric wire (A) outward, the first cable-stripping blade (41) in the first cable-stripping groove (14) can remove a jacket from the to-be-striped end (A1) of the electric wire (A) and expose a core (A2) of the electric wire (A), as shown in FIG. 9. After the stripping operation, the pressing plate (3) can no more be pressed, and the spring member (2) can therefore be released to return the pressing plate (3) to its initial position, as shown in FIG. 5.

The second cable-stripping groove (15) can be used to strip another electric wire having a diameter different from that of the electric wire (A) by repeating the aforementioned operation. It is to be understood that the present invention may have more than two cable-stripping grooves for serving more kinds of electric wires.

In an alternative embodiment of the present invention, only one side of the combining portion of the grip is provided with a single said cable-stripping groove and a single knife having the cable-stripping blade. By repeating the aforementioned operation, with special attention paid to the range the pressing plate approaching the cable-stripping groove, the single-side cable-stripping structure can also effectively strip electric wires having different diameters.

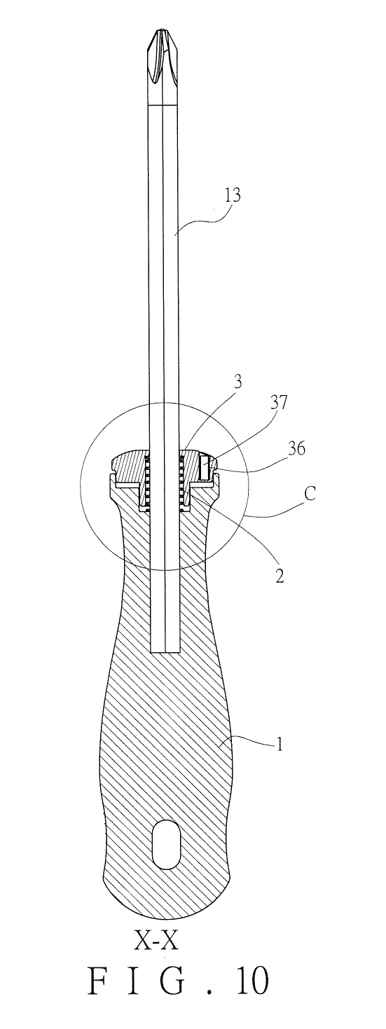

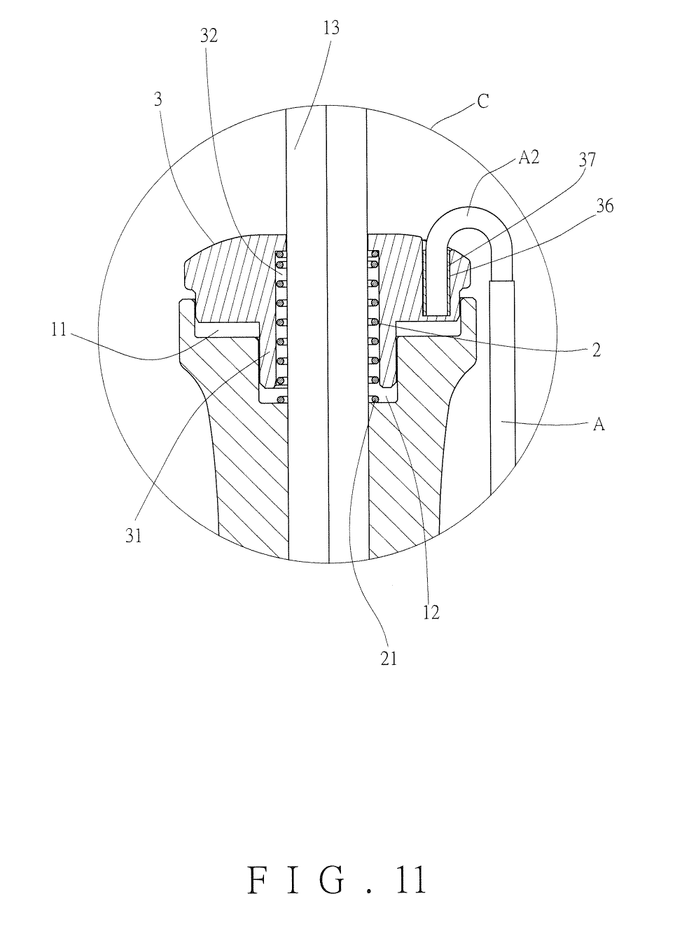

Referring to FIG. 10 and FIG. 11, when there is a need for bending the core (A2) of the electric wire (A), it can be easily done by inserting the core (A2) of the electric wire (A) into the fixing hole (36) of the pressing plate (3). At this time, the sleeve (37) in the fixing hole (36) can hold the core (A2) in position and then a force can be applied to bend the electric wire (A), thereby posing the core (A2) of the electric wire (A) into a desired angle for facilitating subsequent wire welding.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A screwdriver having a cable-stripping structure, the screwdriver having a grip and a screw-driving shaft, and the cable-stripping structure being characterized in:
the grip including a combining portion having a receiving recess for allowing the screw-driving shaft to be inserted therein, wherein the combining portion further has at least one cable-stripping groove, a slit extending from a periphery of the combining portion toward and crossing the cable-stripping groove, and a through hole communicating the slit and the receiving recess;
a spring member being mounted around the screw-driving shaft and having a first end and a second end, wherein the first end is received in the receiving recess of the grip;
a pressing plate being combined with the combining portion of the grip, wherein the pressing plate has a retaining hole corresponding to the through hole, an abutting groove corresponding to the cable-stripping groove, and a fixing hole; and
a knife being installed in the slit of the grip, and having at least one cable-stripping blade that is sized and shaped in accordance with and aligned with the cable-stripping groove, wherein the knife further has a retaining block passing through the through hole and the retaining hole successively, so that the pressing plate is allowed to be moved along the screw-driving shaft by a pressing force in a positionally controlled manner.

2. The screwdriver of claim 1, wherein the combining portion of the grip has two said cable-stripping grooves that are two round-bottom grooves having different diameters, and two said knives are provided to mate the two cable-stripping grooves, in which each of the two knives has a said cable-stripping blade that is sized and shaped in accordance with a corresponding one of said two cable-stripping grooves.

3. The screwdriver of claim 2, wherein the two cable-stripping grooves are parallel to each other.

4. The screwdriver of claim 2, wherein the slit is normal to the cable-stripping groove when crossing the cable-stripping groove.

5. The screwdriver of claim 1, wherein the spring member is a compression spring.

6. The screwdriver of claim 1, wherein the pressing plate has a raised portion, and the raised portion has an axial hole for allowing the screw-driving shaft to pass therethrough.

7. The screwdriver of claim 6, wherein the axial hole of the raised portion receives the second end of the spring member.

8. The screwdriver of claim 6, wherein the retaining hole is correspondingly formed on the raised portion as a lengthwise groove.

9. The screwdriver of claim 1, wherein the abutting groove is a round-bottom groove sized and shaped identically to the cable-stripping groove.

10. The screwdriver of claim 1, wherein the fixing hole is lined by a sleeve.
